(19) United States
(12) Patent Application Publication
(10) Pub. No.: US 2016/0141617 A1
(43) Pub. Date: May 19, 2016

(54) Chromium-doped lithium titanate as cathode material

(71) Applicant: Robert Bosch GmbH, Stuttgart (DE)

(72) Inventors: Pallavi Verma, Leinfelden (DE); Thomas Eckl, Leonberg (DE)

(21) Appl. No.: 14/938,079

(22) Filed: Nov. 11, 2015

(30) Foreign Application Priority Data
Nov. 13, 2014 (DE) 10 2014 223 147.7

(51) Int. Cl. H01M 4/485; C01G 37/00; H01M 10/052

(52) U.S. Cl. CPC H01M 4/485; H01M 10/052; C01G 37/006; H01M 2004/028

(57) ABSTRACT

A cathode material for a lithium cell, in particular a lithium-sulfur cell. To improve the rate properties of the cell, the cathode material includes a chromium-doped lithium titanate, in particular of the general chemical formula: Li₄₋ₓTi₅₋₂ₓCr₃ₓO_{12-δ}, where 0<x<0.6 applies, δ denotes oxygen vacancies, and 0≦δ applies. Also described is a corresponding chromium-doped lithium titanate, a method for the manufacture thereof, and a lithium cell and/or battery equipped therewith.

### RELATED APPLICATION INFORMATION

The present application claims priority to and the benefit of German patent application no. 10 2014 223 147.7, which was filed in Germany on Nov. 13, 2014, the disclosure of which is incorporated herein by reference.

### FIELD OF THE INVENTION

The present invention relates to a cathode material for a lithium cell, to a chromium-doped lithium titanate, to a method for the manufacture thereof, and to a lithium cell and/or lithium battery equipped therewith.

### BACKGROUND INFORMATION

Undoped lithium titanate (Li₄Ti₅O₁₂, LTO) may be used as so-called anode material in a negative electrode, which is also referred to as an anode, of a lithium-ion battery cell.

As a typical spinel structure (A²⁺B³⁺O₄²⁻), undoped lithium titanate is in particular also written in the form of Li(Li_{1/3}Ti_{5/3})O₄. Undoped lithium titanate includes a cubic unit cell of the space group Fd-3m having a lattice constant a of 8.35950 Å. In this, the 8a tetrahedral sites and the 16d octahedral sites are partially occupied by Li⁺ ions, while all Ti⁴⁺ ions and the remaining Li⁺ ions are localized at the 16d octahedral sites.

While undoped lithium titanate has a certain lithium ion conductivity, it has only a very limited electrical conductivity.

In the Journal of Power Sources (2004, 125, 2, pp 242-245), Y.-K. Sun et al. describe electrochemical examinations on Li[Li_{(1-x)/3}CrₓTi_{(5-2x)/3}])O₄, where 0≦x≦1.0, having a spinel structure as anode material for secondary lithium batteries.

Theoretical studies of the effect of a cation doping on the electrical conductivity of Li₄Ti₅O₁₂ are described in Physica Status Solidi (b) (2006, 243, 8, pp 1835-1841).

### SUMMARY OF THE INVENTION

An object of the present invention is a cathode material for a lithium cell which includes a chromium-doped lithium titanate. In particular, the cathode material may be a cathode material for a lithium-sulfur cell, for example a lithium-sulfur solid-state cell.

A cathode material may in particular be understood to mean a material which is configured for forming a positive electrode, which is also referred to as a cathode, of an electrochemical cell, in particular a battery cell, or is contained therein.

It has been shown that the ionic conductivity compared to an undoped lithium titanate, which may have a lithium ion conductivity of 1.2·10⁻⁸ S/cm and a lithium diffusion coefficient of 10⁻¹³ cm²/s, may advantageously be increased with the aid of a chromium doping. Advantageously, lithium ion diffusion coefficients (D_{Li+}) of approximately 10⁻¹¹ to 10⁻¹² cm²/s may be achieved. As a result, chromium-doped lithium titanate may advantageously be used as an, in particular three-dimensional, solid-state lithium ion conductor.

Moreover, the electrical conductivity compared to an undoped lithium titanate, which may have an electrical conductivity of 2.1·10⁻¹¹ S/cm, may also advantageously be slightly increased with the aid of a chromium doping. Electrochemical impedance spectroscopy (EIS) analyses have shown that the electrical conductivity may be increased to >10⁻¹⁰ S/cm with the aid of a chromium doping and may even be increased to >10⁻⁵ S/cm with the aid of oxygen vacancies, which may be inserted, for example, with the aid of calcining, which is described in greater detail hereafter, under a reducing atmosphere. As a result, chromium-doped lithium titanate may advantageously also be used as an, in particular three-dimensional, solid-state electron conductor, and thus in particular also as a so-called mixed conductor.

Chromium-doped lithium titanate, which in particular may be isostructural to undoped lithium titanate, may moreover have a high structural stability and morphology or dimensional stability during an insertion and extraction of lithium ions.

In addition, a chromium doping may advantageously also increase the specific surface area.

Surprisingly, it has been found that chromium-doped lithium titanate, in particular having a spinel structure, is used particularly advantageously as cathode material in electrochemical applications, such as lithium cells, for example lithium-sulfur cells, due to its increased lithium ion conductivity, increased electrical conductivity, high structural stability, and specific surface area. Chromium-doped lithium titanates may in particular be used as conducting matrix material or as a conducting matrix in cathode materials of lithium-sulfur cells, for example lithium-sulfur solid-state cells, whose cathode material—since elemental sulfur itself is insulating—generally requires at least one auxiliary material having a high ionic and electrical conductivity. A chromium-doped lithium titanate may in particular be used as matrix material in a cathode material of a lithium-sulfur cell, for example lithium-sulfur solid-state cells. The chromium-doped lithium titanate may form tree-like structures, which provide lithium ion-conducting and electron-conducting paths for the redox reaction of sulfur and improved sulfur contacting and an improved structural stability of the cathode material.

Due to the increased lithium ion conductivity and electrical conductivity, and in particular also due to the high structural stability during the insertion and extraction of lithium ions and the high specific surface area of the chromium-doped lithium titanate, overall a cell may advantageously be provided having in particular improved rate properties and, for example, an improved capacity reversibility, an improved cycle stability, increased safety, and an extended service life.

Within the scope of one specific embodiment, the cathode material includes a chromium-doped lithium titanate of the general chemical formula:

Li₄₋ₓTi₅₋₂ₓCr₃ₓO_{12-δ}.

In particular, 0<x≦0.6 may apply. δ in particular denotes oxygen vacancies, and in particular 0≦δ may apply. In this way, a good lithium ion conductivity and electrical conductivity may advantageously be implemented. In particular, 0.1≦x≦0.5 may apply. For example, 0.1≦x or 0.2≦ or 0.3≦x and x≦0.5 or x≦0.4 may apply, for example 0.1≦x≦0.4 and/or 0.2≦x≦0.5 and/or 0.3≦x≦0.5. In this way, the lithium ion conductivity and electrical conductivity may advantageously be further increased. Additionally, a good capacity reversibility and cycle stability of a cell, whose cathode material includes the chromium-doped lithium titanate, may advantageously be achieved in this way. In particular, 0.1≦x≦0.4 may apply. In this way, a structure having particularly advantageous properties may advantageously be achieved.

Within the scope of one further specific embodiment, the cathode material furthermore includes sulfur. For example, the cathode material may include a sulfur compound and/or a sulfur-carbon composite and/or elemental sulfur. The cathode material may advantageously be used in a lithium-sulfur cell, for example a lithium-sulfur solid-state cell.

Within the scope of one further specific embodiment, the cathode material furthermore includes carbon, in particular conductive carbon. For example, the cathode material may include (conductive) carbon black. In this way, the properties of a cell configured therewith may be improved, if necessary. For example, the cathode material may include ≧1 wt. % to ≦5 wt. % carbon, in particular conductive carbon, based on the total weight of the cathode material.

Within the scope of one further specific embodiment, 0<δ applies. The electrical conductivity may advantageously be considerably increased by oxygen vacancies. Oxygen vacancies may in particular be formed with the aid of calcining under a reducing atmosphere.

Within the scope of one special configuration of this specific embodiment (0<δ), the cathode material is free of conductive carbon, in particular carbon-free. If necessary, the cathode material may even be free of conductive additive. Through chromium-doped lithium titanates having oxygen vacancies (0<δ), it was advantageously possible, even without the addition of (conductive) carbon, and thus with an increase in the specific capacity, to achieve comparably good rate properties and a comparably good reversibility as through a combination of chromium-doped lithium titanates without oxygen vacancies (δ=0) and (conductive) carbon.

Within the scope of one further specific embodiment, δ=0 applies. In this way, a higher lithium ion conductivity may advantageously be achieved. Oxygen vacancies may be avoided with the aid of calcining under an air atmosphere. In this case, the chromium-doped lithium titanate may have the general chemical formula Li₄₋ₓTi₅₋₂ₓCr₃ₓO₁₂.

Within the scope of one special configuration of this specific embodiment (δ=0), the cathode material includes carbon, in particular conductive carbon. Through a combination of chromium-doped lithium titanate (δ=0) which is free of oxygen vacancies, and in particular calcined under an air atmosphere, and (conductive) carbon, the rate properties of a cell equipped therewith, in particular as cathode material, may advantageously be improved.

In particular, the cathode material may include a chromium-doped lithium titanate according to the present invention and/or a chromium-doped lithium titanate manufactured using a method according to the present invention.

With respect to further technical features and advantages of the cathode material according to the present invention, reference is hereby explicitly made to the explanations provided in conjunction with the lithium titanate according to the present invention, the method according to the present invention, and the cell and battery according to the present invention, and to the figures and description of the figures.

Another object of the present invention is a chromium-doped lithium titanate, in particular having a spinel structure, which has the general chemical formula:

Li₄₋ₓTi₅₋₂ₓCr₃ₓO_{12-δ}

0<x≦0.6, in particular 0.1≦x≦0.5, may apply. δ in particular denotes oxygen vacancies, and in particular 0<δ may apply. In this way, a good lithium ion conductivity and electrical conductivity may advantageously be implemented.

Within the scope of one specific embodiment, 0<δ applies. The electrical conductivity may advantageously be considerably increased by oxygen vacancies. Oxygen vacancies may in particular be formed with the aid of calcining under a reducing atmosphere.

For example, 0.1≦x or 0.2≦ or 0.3≦x and x≦0.5 or x≦0.4 may apply, for example 0.1≦x≦0.4 and/or 0.2≦x≦0.5 and/or 0.3≦x≦0.5. In this way, the lithium ion conductivity and electrical conductivity may advantageously be further increased. Additionally, a good capacity reversibility and cycle stability of a cell, whose cathode material includes the chromium-doped lithium titanate, may advantageously be achieved in this way.

Within the scope of one further specific embodiment, thus 0.1≦x≦0.5 applies. In particular, 0.1≦x≦0.4 may apply. In this way, a structure having particularly advantageous properties may advantageously be achieved.

Within the scope of one further specific embodiment, δ=0 applies. In this way, a higher lithium ion conductivity may advantageously be achieved. Oxygen vacancies may be avoided with the aid of calcining under an air atmosphere. In this case, the chromium-doped lithium titanate may have the general chemical formula Li₄₋ₓTi₅₋₂ₓCr₃ₓO₁₂.

Within the scope of one further specific embodiment, the chromium-doped lithium titanate is manufactured using a method according to the present invention. A manufacture according to the present invention may be verified, for example, with the aid of X-ray diffraction (XRD), scanning electron microscopy (SEM) and/or BET measurement.

With respect to further technical features and advantages of the lithium titanate according to the present invention, reference is hereby explicitly made to the explanations provided in conjunction with the cathode material according to the present invention, the method according to the present invention, and the cell and battery according to the present invention, and to the figures and description of the figures.

The present invention furthermore relates to a method for the synthesis of a chromium-doped lithium titanate, in particular having a spinel structure.

In the method, in particular a chromium-doped lithium titanate may be manufactured with the aid of solid-state synthesis. In addition to the above-described advantages, the spinel phase portion may advantageously be increased and impurities be reduced as a result of the chromium doping. Chromium and titanium may advantageously (directly) be used stoichiometrically in the solid-state synthesis.

For example, in the solid-state synthesis, chromium may be used at a molar ratio to titanium which is in a range from 1:2 to 1:32, i.e., 1 (chromium atom) to 2 (titanium atoms) to 1 (chromium atom) to 32 (titanium atoms). In particular, chromium may be used at a molar ratio to titanium which is in a range from 1:2 to 1:16. For example, chromium may be used at a molar ratio to titanium which is in a range from 1:2.5 to 1:8, for example 1:2.5 to 1:3 to 1:5. In this way, the lithium ion conductivity may advantageously be further optimized. This is because it has been found that a particularly high lithium ion conductivity is achievable by a molar ratio of chromium to titanium around approximately 1:3.5, such as in Li₄₋ₓTi₅₋₂ₓCr₃ₓO₁₂ where x=0.4, i.e., Li_{3.6}Ti_{4.2}Cr_{1.2}O₁₂, while the lithium ion conductivity may decrease again at too low a titanium portion, for example at a molar ratio of chromium to titanium of 1:1.7, such as in Li₄₋ₓTi₅₋₂ₓCr₃ₓO₁₂ where x=0.7, i.e., Li_{3.3}Ti_{3.6}Cr_{2.1}O₁₂.

In particular, the chromium-doped lithium titanate may be calcined in the solid-state synthesis. In particular, a spinel structure may form in this process.

The calcining may be carried out under a reducing atmosphere or under an air atmosphere, for example.

Within the scope of one embodiment, the calcining takes place under an air atmosphere. In this way, chromium-doped lithium titanate free of oxygen vacancies (δ=0) may advantageously be manufactured. With the aid of a solid-state synthesis in the scope of which calcining takes place under an air atmosphere, chromium-doped lithium titanate which is free of oxygen vacancies and has an approximately 100% spinel phase may advantageously be manufactured.

Within the scope of another specific embodiment, the calcining is carried out under a reducing atmosphere. Calcining under a reducing atmosphere advantageously allows oxygen vacancies to be inserted into the chromium-doped lithium titanate. In this way, chromium-doped lithium titanate having oxygen vacancies (0<δ) may advantageously be manufactured. With the aid of a solid-state synthesis in the scope of which calcining takes place under a reducing atmosphere, chromium-doped lithium titanate which has oxygen vacancies and an approximately 100% spinel phase may advantageously be manufactured.

By inserting the oxygen vacancies, the electrical conductivity may advantageously be considerably further increased. In addition to the formation of oxygen vacancies, the calcining under a reducing atmosphere may also result in a reduction of tetravalent titanium (Ti⁴⁺) to trivalent titanium (Ti³⁺), which may also advantageously affect the electrical conductivity. Since the radius of trivalent titanium (r(Ti³⁺)) is greater than the radius of tetravalent titanium (r(Ti⁴⁺), the lattice constant may thereby be increased. However, oxygen vacancies may possibly trap lithium vacancies, which may result in a slight reduction in the ionic conductivity. However, since as a result of the calcining under a reducing atmosphere and the insertion of oxygen vacancies or the reduction to trivalent titanium (Ti³⁺), the electrical conductivity is considerably further increased by several orders of magnitude, in particular to >10⁻⁵ S/cm, the calcining under a reducing atmosphere and the insertion of oxygen vacancies may overall have an advantageous effect.

Moreover, the calcining under a reducing atmosphere may further improve the morphology or specific surface area.

For example, the reducing atmosphere may be a hydrogen-containing atmosphere. For example, the reducing atmosphere may include ≧1 vol. % to ≦30 vol. % hydrogen and ≧70 vol. % to ≦99 vol. % of at least one inert gas, in particular argon.

Within the scope of one further specific embodiment, the calcining, for example in method step c), is carried out at a temperature of ≧500° C. The calcining may in particular be carried out at a temperature of ≧550° C., for example ≧600° C., for example ≧650° C. For example, the calcining may be carried out at a temperature of ≧700° C., or of ≧750° C., if necessary. For example, the calcining, such as under a reducing atmosphere and/or under an air atmosphere, may be carried out at a temperature of ≧700° C., for example of ≧750° C., for example at approximately 800° C.

The calcining may be carried out in a furnace, for example. In particular, stoichiometric amounts of at least one lithium salt, at least one titanium oxide, in particular titanium dioxide (TiO₂), and at least one chromium salt, in particular chromium oxide, may be used during the solid-state synthesis. The at least one lithium salt may include or be lithium carbonate (Li₂CO₃), for example. The at least one titanium oxide may in particular include or be titanium dioxide (TiO₂). The at least one chromium salt may include or be a chromium oxide, for example.

In particular, a chromium(III)salt may be used in the solid-state synthesis. The at least one chromium salt may thus include in particular a chromium(III)salt. In this way, a doping with trivalent chromium (Cr³⁺) may advantageously be achieved. Trivalent chromium (Cr³⁻′) may advantageously be electrochemically inactive in electrochemical reactions, in particular in lithium-sulfur cells. A doping with trivalent chromium (Cr³⁺) has proven to be particularly advantageous also for calcining under a reducing atmosphere for the insertion of oxygen vacancies since, during calcining under a reducing atmosphere, trivalent chromium (Cr³⁺)—in contrast to trivalent iron (Fe³⁺), which would rather be reduced during calcining under a reducing atmosphere than form electrical conductivity-increasing oxygen vacancies—is able to remain stable and thereby allows a formation of oxygen vacancies. For example, the at least one chromium salt may include or be chromium(III)oxide (Cr₂O₃).

In particular, the at least one lithium salt, the at least one titanium dioxide, and the at least one chromium salt may be ground prior to the solid-state synthesis, in particular the calcining. For example, the grinding may take place in at least one solvent, for example isopropanol. The grinding may take place using a ball mill, for example, such as containing zirconia balls. The grinding may be carried out, for example, at a rotational speed in a range from ≧50 rpm to ≦300 rpm, for example from ≧100 rpm to ≦200 rpm, for example at approximately 150 rpm. Grinding may take place for >1 hr, for example approximately 2 hrs, for example. After the grinding, the at least one solvent may be removed, such as with the aid of a rotary evaporator, for example at a temperature of ≧30° C. and ≦100° C., for example at approximately 70° C.

The method may in particular be configured for the synthesis of a cathode material according to the present invention and/or a chromium-doped lithium titanate according to the present invention, in particular having a spinel structure.

With respect to further technical features and advantages of the method according to the present invention, reference is hereby explicitly made to the explanations provided in conjunction with the cathode material according to the present invention, the lithium titanate according to the present invention, and the cell and battery according to the present invention, and to the figures and description of the figures.

The present invention further relates to a lithium cell and/or a lithium battery which includes a cathode material according to the present invention and/or a lithium titanate according to the present invention and/or a lithium titanate manufactured using a method according to the present invention.

The lithium cell and/or lithium battery may in particular include a cathode, which may also be referred to as a positive electrode, and an anode, which may also be referred to a negative electrode.

In particular, the cell may include an anode containing lithium. For example, the anode may be a lithium-metal anode. The anode may include metallic lithium or a lithium alloy, in particular as anode material, for example.

Within the scope of one specific embodiment, the lithium cell and/or lithium battery is/are a lithium-sulfur cell and/or battery. Lithium-sulfur cells may advantageously have a high theoretical specific charge, such as of approximately 1675 mAh/g, and a high theoretical specific density, such as of approximately 2500 Wh/kg. Moreover, lithium-sulfur cells may be environmentally friendly and manufactured cost-effectively.

The lithium cell and/or lithium battery may in particular include a sulfur-containing cathode. In particular, the cathode may include a cathode material according to the present invention and/or the chromium-doped lithium titanate according to the present invention or be formed thereof.

The cell may furthermore include at least one solid electrolyte. For example, the at least one solid electrolyte may be an inorganic, such as a ceramic and/or vitreous, solid electrolyte.

The cell may include at least one solid electrolyte layer between the anode and the cathode, for example. The solid electrolyte layer may in particular include at least one inorganic, such as a ceramic and/or vitreous, solid electrolyte or be formed thereof. In this way, a growth of lithium dendrites from the anode to the cathode and a reaction of anode-side lithium with cathode-side polysulfides and/or electrolyte may be prevented, and lithium polysulfides may be retained on the cathode side. In this way, in turn, the safety and service life of the cell may advantageously be further improved.

Within the scope of one further specific embodiment, the lithium cell and/or lithium battery is/are a lithium-sulfur solid-state cell and/or battery. A solid-state cell and/or battery may in particular be understood to mean an electrochemical cell or battery which includes only solid materials and is free of liquid electrolyte, for example. Instead of liquid electrolyte, the cell may in particular include at least one solid electrolyte.

With respect to further technical features and advantages of the cell and/or battery according to the present invention, reference is hereby explicitly made to the explanations provided in conjunction with the method according to the present invention, the lithium titanate according to the present invention and the cathode material according to the present invention, and to the figures and description of the figures.

### DRAWINGS AND EXEMPLARY EMBODIMENTS

Further advantages and advantageous embodiments of the subject matters according to the present invention are illustrated in the drawings and described in the following description. It should be noted that the drawings are only of a descriptive nature and are not intended to limit the present invention in any way.

### BRIEF DESCRIPTION OF THE DRAWINGS

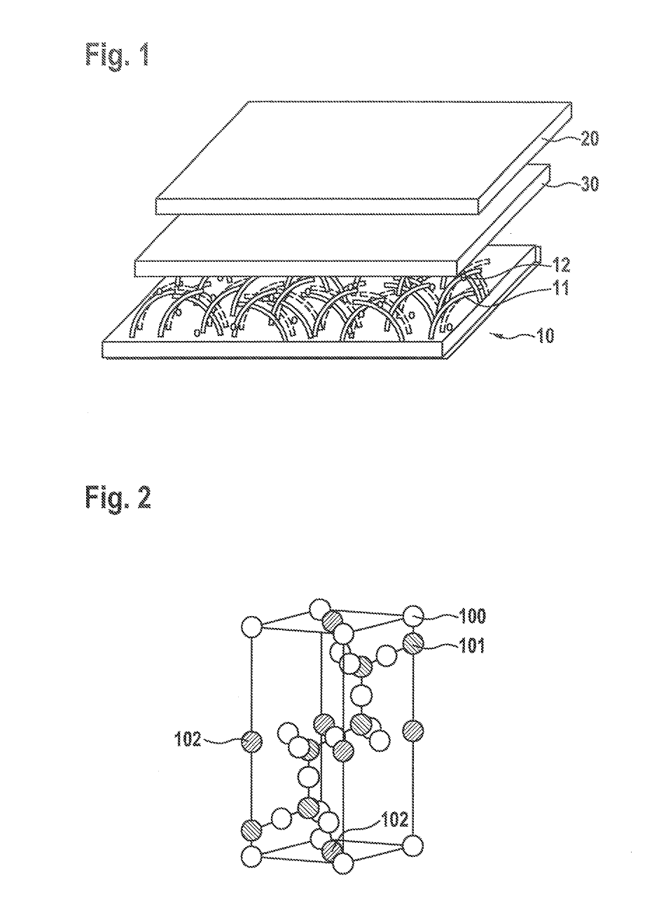

FIG. 1 shows a schematic, perspective view of one specific embodiment of a cell according to the present invention.

FIG. 2 shows a schematic, perspective view of a structure of a three-dimensional lithium diffusion network as a basis for ab initio calculations.

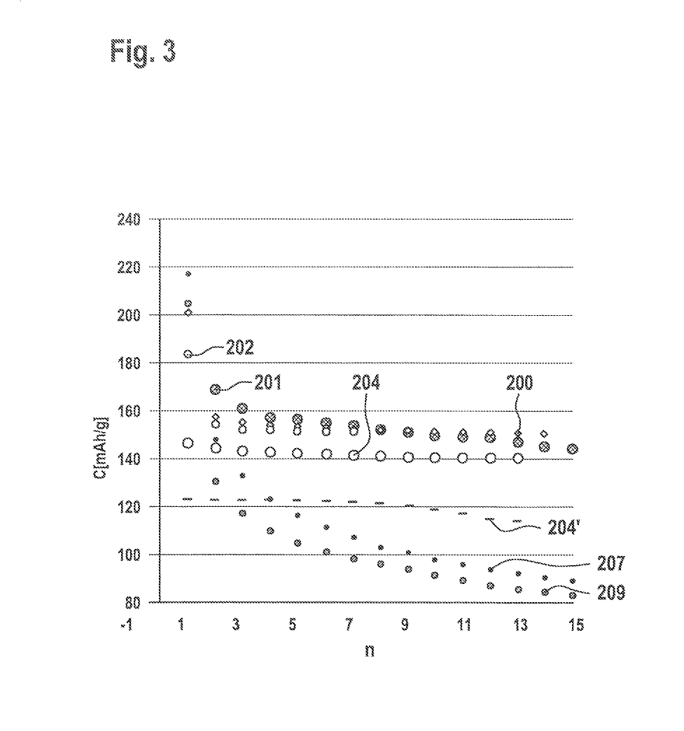

FIG. 3 shows a graph to illustrate the cycle stability.

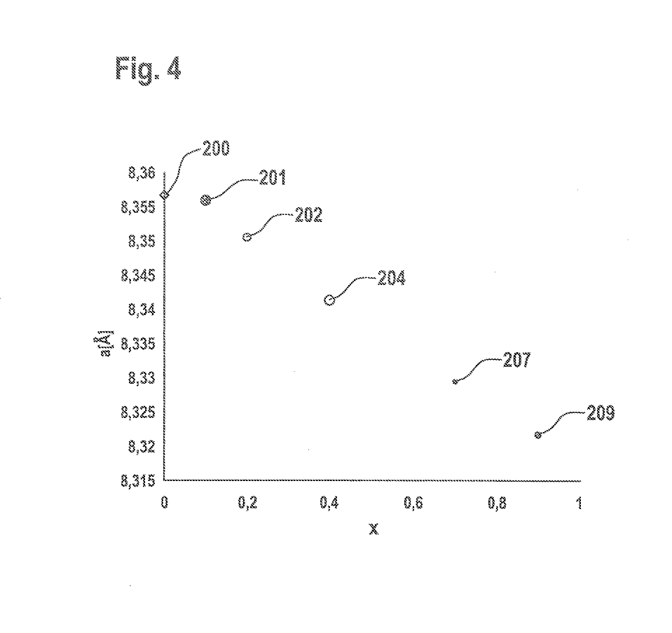

FIG. 4 shows a graph to illustrate the lattice constant a [Å] compared to x in Li₄₋ₓTi₅₋₂ₓCr₃ₓO₁₂.

### DETAILED DESCRIPTION

FIG. 1 shows that the cell includes a cathode 10, an anode 20, and a solid electrolyte layer 30 situated in between. Anode 20 includes metallic lithium. Cathode 10 includes sulfur 12 and nanostructures 11 made of a chromium-doped lithium titanate. Nanostructures 11 formed of the chromium-doped lithium titanate are in particular lithium ion-conducting and electron-conducting. FIG. 1 illustrates that nanostructures 11 are configured in the form of nanowires, which form tree-like structures for contacting sulfur 12.

### Exemplary Embodiments

### A. Solid-State Synthesis

### 1. Solid-State Synthesis of Particles Made of Chromium-Doped Lithium Titanate: Li₄₋ₓTi₅₋₂ₓCr₃ₓO₁₂ where x=0.1, 0.2, 0.4, 0.7 and 0.9

A number of chromium-doped lithium titanates of the general chemical formula: Li₄₋ₓTi₅₋₂ₓCr₃ₓO₁₂ where x=0.1, 0.2, 0.4, 0.7 and 0.9 were synthesized with the aid of an, in particular ceramic, solid synthesis.

Stoichiometric amounts of lithium carbonate (Li₂CO₃), titanium dioxide (TiO₂), and chromium(III)oxide (Cr₂O₃) were mixed with 40 ml isopropanol and ground for two hours at 150 rpm using a ball mill containing zirconia balls and then dried at 70° C. with the aid of a rotary evaporator. Subsequently, the residue was calcined in a furnace at 800° C. in air. After completion of the calcination and cooling of the furnace, the sample was removed and ground manually. The resulting products had a green color.

### 2. Solid-State Synthesis of Particles Made of Chromium-Doped Lithium Titanate Having Oxygen Vacancies: Li₄₋ₓTi₅₋₂ₓCr₃ₓO_{12-δ} where x=0.2 and 0.4

Synthesis 2 was carried out analogously to Synthesis 1; however, the calcining was carried out at 800° C. under a reducing atmosphere made of 10% hydrogen (H₂) and 90% argon (Ar). The resulting products had a blue color.

### 3. Comparison Example

### Solid-State Synthesis of Particles Made of Undoped Lithium Titanate: Li₄Ti₅O₁₂

Stoichiometric amounts of lithium carbonate (Li₂CO₂) and titanium dioxide (TiO₂) were mixed with 40 ml isopropanol and ground for two hours at 150 rpm using a ball mill containing zirconia balls and then dried at 70° C. with the aid of a rotary evaporator. Subsequently, the residue was calcined in a furnace at 800° C. in air. After completion of the calcination and cooling of the furnace, the sample was removed and ground manually. The resulting product had a white color.

### 4. Comparison Example

### Solid-State Synthesis of Particles Made of Undoped Lithium Titanate Having Oxygen Vacancies: Li₄Ti₅O_{12-δ}

Synthesis 4 was carried out analogously to Synthesis 3; however, the calcining was carried out at 800° C. under a reducing atmosphere made of 10% hydrogen (H₂) and 90% argon (Ar). The resulting product had a blue color.

The products of the syntheses were examined with the aid of X-ray diffraction (XRD), galvanostatic intermittent titration technique (GITT) analysis, electrochemical impedance spectroscopy (EIS), and Rietveld analysis.

### B. Cell Assembly for Electrochemical Tests

Manufacture of cathodes (positive electrodes) including an aluminum current collector:

Li₄₋ₓTi₅₋₂ₓCr₃ₓO₁₂ where x=0.1, 0.2, 0.4, 0.7 and 0.9 from Synthesis 1 and Li₄Ti₅O₁₂ from Comparison Example Synthesis 3 were each mixed with 8 wt. % polyvinylidene fluoride (PVDF) as the binder and carbon black. An aluminum current collector was coated with the mixtures with the aid of tape casting.

Moreover, Li₄₋ₓTi₅₋₂ₓCr₃ₓO_{12-δ} where x=0.4 from Synthesis 2 was mixed with 8 wt. % polyvinylidene fluoride (PVDF) as the binder, without the addition of carbon black, and an aluminum current collector was coated with the mixture with the aid of tape casting.

The cathode-aluminum current collector assemblies thus manufactured were each assembled with a glass fiber separator, which was saturated with a non-aqueous liquid electrolyte made of 500 μl of a 1 M lithium hexafluorophosphate (LiPF₆) solution in ethylene carbonate and dimethyl carbonate (1:1 (vol. %), and a lithium foil as the anode (negative electrode) to form lithium cells.

The rate properties and the cycle stability were tested on the lithium cells.

### C. X-Ray Diffraction Analysis

The X-ray diffraction analysis shows that the chromium-doped lithium titanates according to Synthesis 1 all had similar diffractograms and an approximately 100% spinel phase. The lattice constant a decreased as the amount of chromium increased. The lattice constants a of the chromium-doped lithium titanates according to Synthesis 1 are shown in FIG. 4 and Table 1.

TABLE 1
Lattice constants of the chromium-doped lithium
titanates according to Synthesis 1:

| Li₄₋ₓTi₅₋₂ₓCr₃ₓO₁₂ | a [nm] |
|---|---|
| x = 0 (Li₄Ti₅O₁₂) | 0.835685 |
| x = 0.1 (Li_{3.9}Ti_{4.8}Cr_{0.3}O₁₂) | 0.83447 |

The chromium-doped lithium titanates having oxygen vacancies according to Synthesis 2 also had diffractograms which were similar to each other and an approximately 100% spinel phase. The Rietveld analysis was used to ascertain the lattice constants a and the occupancy of the 16d octahedral site of the spinel phase. The occupancy of the 16d octahedral site was able to be adapted using Ti³⁺ and Cr³⁺. It is assumed that chromium—as well as titanium—occupies the 16d octahedral site, and not the 8a or 16c tetrahedral site and thus the lithium ion transport is not impaired by the chromium. The occupancy of the 16d octahedral site of the spinel phase of the chromium-doped lithium titanates having oxygen vacancies according to Synthesis 2 is shown in Table 2.

TABLE 2
Lattice constants and occupancy of the 16d octahedral site
of the spinel phase of the chromium-doped lithium titanates
having oxygen vacancies according to Synthesis 2:

| | | Occupancy of the 16d |
|---|---|---|
| | a [nm] | octahedral site |
| Li_{3.9}Ti_{4.8}Cr_{0.6}O_{12-δ} | 0.835741 | 0.883 (Ti³⁺ 0.736; Cr³⁺ 0.147) |
| Li_{3.6}Ti_{4.2}Cr_{1.2}O_{12-δ} | 0.834947 | 0.928 (Ti³⁺ 0.663; Cr³⁺ 0.265) |

A comparison of Tables 1 and 2 shows that the chromium-doped lithium titanates having oxygen vacancies according to Synthesis 2 had greater lattice constants a than the corresponding chromium-doped lithium titanates without oxygen vacancies according to Synthesis 1.

### D. Ascertainment of the Lithium Diffusion Coefficient (D_{Li+}) with the Aid of GITT Diffusion Coefficient Analysis, Electrochemical Impedance Spectroscopic Measurements and Ab Initio Calculations

The lithium diffusion coefficients (D_{Li+}) of the samples were measured at ˜2 V against Li/Li⁺ with the aid of GITT diffusion coefficient analysis. The diffusion coefficients (D_{Li+}) of the chromium-doped lithium titanates according to Synthesis 1 are shown in Table 3.

TABLE 3
Diffusion coefficients (D_{Li+}) of the chromium-
doped lithium titanates according to Synthesis 1:

| Li₄₋ₓTi₅₋₂ₓCr₃ₓO₁₂ | D_{Li+} [cm²/s] |
|---|---|
| x = 0.1 (Li_{3.9}Ti_{4.8}Cr_{0.3}O₁₂) | 6 · 10⁻¹³ |
| x = 0.2 (Li_{3.8}Ti_{4.6}Cr_{0.6}O₁₂) | 8 · 10⁻¹³ |
| x = 0.4 (Li_{3.6}Ti_{4.2}Cr_{1.2}O₁₂) | 7 · 10⁻¹² |
| x = 0.7 (Li_{3.3}Ti_{3.6}Cr_{2.1}O₁₂) | 1.8 · 10⁻¹⁵ |
| x = 0.9 (Li_{3.1}Ti_{3.2}Cr_{2.7}O₁₂) | 4 · 10⁻¹⁴ |

Table 3 shows that the chromium-doped lithium titanates where x=0.1, 0.2 and 0.4 according to Synthesis 1 had higher lithium diffusion coefficients (D_{Li+}), and thus a higher lithium ion conductivity, than undoped lithium titanate. Table 3 further shows that the chromium-doped lithium titanates where x=0.1, 0.2 and 0.4 according to Synthesis 1 also had higher lithium diffusion coefficients (D_{Li+}), and thus a higher lithium ion conductivity, than the chromium-doped lithium titanates where x=0.7 and 0.9 according to Synthesis 1. In particular, Table 3 shows that the chromium-doped lithium titanate where x=0.4 (Li_{3.6}Cr_{1.2}Ti_{4.2}O₁₂) according to Synthesis 1 had the highest lithium diffusion coefficient (D_{Li+}), and thus the highest lithium ion conductivity. The optimal range for a chromium doping with respect to the lithium ion conductivity thus seems to lie in the range 0<x<0.6, and in particular in the range 0.1≦x≦0.5.

To simulate the influence of a chromium doping or of the insertion of oxygen vacancies on the ionic conductivity of lithium titanate having a spinel structure, ab initio calculations were carried out based on the structure of a three-dimensional lithium diffusion network shown in FIG. 2. FIG. 2 shows octahedral sites 100 and tetrahedral sites 101, whereby lithium sites 102 were fixed in the calculations.

The ionic conductivity was calculated with the aid of the transition state theory (TST; also Eyring theory). For this purpose, the ionic diffusion coefficient was correlated with the ionic conductivity, and the diffusion of an ion between two positions was examined. According to the transition state theory, the reaction rate follows an Arrhenius-like equation. Using the density functional theory (DFT), the energies and forces of each configuration were calculated. The minimum energy path, which represents the most likely transition path, was calculated with the aid of the nudged elastic band method.

The simulations showed that a volume change should not influence a jumping of lithium vacancies in the spinel structure. The simulations furthermore showed that oxygen vacancies seem to trap lithium vacancies and significantly increase the energy barriers. Chromium ions, in contrast, seem to be accompanied by a less pronounced trapping of vacancies and a slight reduction of the energy barriers.

To estimate the influence of a chromium doping and of an insertion of oxygen vacancies on ionic conductivity of lithium titanate having a spinel structure, diffusion coefficients (D^{Li+}) were calculated with the aid of a very simple “lattice gas” model and shown in Table 4.

TABLE 4
Calculated diffusion coefficients (D_{Li+}):

| | | | ~ν | Diffusion coefficient D_{Li+} [cm²/s] | | |
|---|---|---|---|---|---|---|
| Structure | I [Å] | ΔE [eV] | [THz] | T = 300 K | T = 600 K | T = 900 K |
| Li₄Ti₅O₁₂ | 3.61 | 0.40 | 7.2 | 1.8 · 10⁻⁹ | 4.1 · 10⁻⁶ | 5.4 · 10⁻⁵ |
| Li₄₋ₓTi₅₋₂ₓCr₃ₓO₁₂ | 3.57 | 0.45 | 7.9 | 2.8 · 10⁻¹⁰ | 1.8 · 10⁻⁶ | 1.8 · 10⁻⁵ |
| Li₄Ti₅O_{12-δ} | 3.63 | 0.65 | 4.9 | 7.7 · 10⁻¹⁴ | 2.2 · 10⁻⁸ | 1.5 · 10⁻⁶ |

Table 5 shows the diffusion coefficients (D_{Li+}) calculated for a temperature of 300 K and corresponding diffusion coefficients (D_{Li+}) measured with the aid of GITT, and ionic conductivities measured with the aid of electrochemical impedance spectroscopy.

TABLE 5
Predicted and measured effects of a chromium doping and an insertion
of oxygen vacancies on the diffusion coefficient (D_{Li+}) and the
ionic conductivity of lithium titanate having a spinel structure:

| | | Measured D^{Li+} | |
|---|---|---|---|
| | Predicted D_{Li+} | at T ~300 K | Measured ionic |
| Structure | at T = 300 K | [cm²/s] | conductivity |
| Li₄Ti₅O₁₂ | 1.8 · 10⁻⁹ | 10⁻¹³ | 1.2 · 10⁻⁸ |
| Li_{3.6}Ti_{4.2}Cr_{1.2}O₁₂ | 2.8 · 10⁻¹⁰ | 7 · 10⁻¹² | 3.1 · 10⁻⁸ |
| Li₄Ti₅O_{12-δ} | 7.7 · 10⁻¹⁴ | | 4.0 · 10⁻⁹ |

The measured diffusion coefficients (D_{Li+}) and ionic conductivities in Table 5 show that chromium ions slightly increase the diffusion coefficient and the ionic conductivity, while oxygen vacancies slightly decrease the diffusion coefficient and the ionic conductivity. However, Table 5 also shows that the simulations were only able to predict that a chromium doping should have a more positive effect on the diffusion coefficient (D_{Li+}) and the ionic conductivity than an insertion of oxygen vacancies.

### E. Ascertainment of the Electrical Conductivity with the Aid of Electrochemical Impedance Spectroscopic Measurements and Ab Initio Calculations

Electrochemical impedance spectroscopic measurements of the electrical conductivity showed that the chromium-doped lithium titanates according to Syntheses 1 and 2 also had a higher electrical conductivity than undoped lithium titanate. In particular, the chromium-doped lithium titanates calcined under an air atmosphere according to Synthesis 1 had an electrical conductivity of >10⁻¹⁰ S/cm. The chromium-doped lithium titanates calcined under a reducing atmosphere according to Synthesis 2 had a very high electrical conductivity, in particular of >10⁻⁵ S/cm.

To simulate the influence of a chromium doping or of the insertion of oxygen vacancies on the electrical conductivity of lithium titanates having a spinel structure, ab initio calculations were carried out based on the structure of a three-dimensional lithium diffusion network shown in FIG. 2. FIG. 2 shows octahedral sites 100 and tetrahedral sites 101, whereby lithium sites 102 have been fixed in the calculations.

The electrical conductivity was calculated with the aid of the density functional theory. The density functional theory is a quantum mechanical description of electrons in a crystal having fixed nuclei and is based on the stationary Schrödinger equation. To determine the properties in the ground state, the energy as a function of the electron density was minimized, whereby a many-body problem became a one-body problem (Kohn-Sham equations). The density of states and Fermi energy were determined, in particular directly, with the aid of the density functional theory. In particular, the densities of states of electrons in the valence band and in the conduction band were determined. To determine the positions of the doping elements, energetic calculations were carried out with the aid of the density of states, and conclusions were drawn based on the most stable structures.

Moreover, the calculations showed that, as a result of the insertion of oxygen vacancies, which is also accompanied by a formation of Ti³⁺:

O²⁻₃₂ₑ+2Ti⁴⁺_{16d}->O+2Ti³⁺_{16d},

the conduction band should be partially occupied at a very high level. As a result, an insertion of oxygen vacancies should also very drastically increase the electrical conductivity compared to undoped lithium titanate having a spinel structure.

The calculations furthermore showed that a chromium doping:

2Ti⁴⁺_{16d}+Li⁺_{16d}+3Cr->3Cr³⁺_{16d}+Li+2Ti

should completely change the density of states and result in new states, a partially filled conduction band, and a defect level.

The simulations thus showed that both the insertion of oxygen vacancies and a chromium doping should result in a considerable increase in the electrical conductivity. A comparison between the effect of a chromium doping, or of an insertion of oxygen vacancies, on the electrical conductivity of lithium titanate having a spinel structure, as predicted with the aid of the simulations, and the electrical conductivities of corresponding compounds, as measured with the aid of electrochemical impedance spectroscopy, is shown in Table 6.

TABLE 6
Predicted and measured effects of a chromium doping and
an insertion of oxygen vacancies on the electrical conductivity
of lithium titanate having a spinel structure:

| | Predicted effect on | |
|---|---|---|
| | the electrical | Measured electrical |
| Structure | conductivity | conductivity [S/cm] |
| Li₄Ti₅O₁₂ | | 2.1 · 10⁻¹¹ |
| Li₄₋ₓTi₅₋₂ₓCr₃ₓO₁₂ | Drastic increase | 1.4 · 10⁻¹⁰ |
| Li₄Ti₅O_{12-δ} | Drastic increase | 2.0 · 10⁻⁵ |

Table 6 shows that, while there is a slight increase in the electrical conductivity of lithium titanate from doping with chromium ions, it is not as drastic as predicted by the simulations.

With respect to the effect of an insertion of oxygen vacancies on the electrical conductivity of lithium titanate, Table 6 in contrast shows that the electrical conductivity is increased drastically by the insertion of oxygen vacancies, as predicted by the simulations.

The compilation of the measured conductivities in Table 6 consequently indicates that the formation of oxygen vacancies and trivalent titanium (Ti³⁺) seem to have a greater influence on the electrical conductivity than the substitution of tetravalent titanium (Ti⁴⁺) with chromium.

Consequently, the trend could be correctly determined by the simulations. The density functional theory and the density of states analysis thus seem to represent a fast option, at least for systems with little correlation, to be able to roughly estimate the influence of dopings on the electrical conductivity of lithium titanate. The density of states, however, does not seem to suffice for quantitative predictions and seems to provide only an impression of the number of the charge carriers. A simulation of the mobility of the charge carriers seems to necessitate calculations using other ways.

### F. Ascertainment of the Rate Properties

The rate tests showed that the best results and a good reversibility could be achieved by a combination of the chromium-doped lithium titanates free of oxygen vacancies from Synthesis 1 with carbon black. However, chromium-doped lithium titanates having oxygen vacancies from Synthesis 2 advantageously allowed comparably good results and a comparably good reversibility to be achieved, even without the addition of carbon black, as was possible by a combination of the chromium-doped lithium titanates free of oxygen vacancies from Synthesis 1 with carbon black. The good rate properties of the chromium-doped lithium titanates having oxygen vacancies from Synthesis 2 (without carbon black) appear to be based on their high electrical conductivity.

### G. Ascertainment of the Capacity Reversibility and Cycle Stability

The capacity reversibility and cycle stability at C/20 were have been measured of Li₄₋ₓTi₅₋₂ₓCr₃ₓO₁₂ where x=0.1 (201), x=0.2 (202), x=0.4 (204), x=0.7 (207), and x=0.9 (209) from Synthesis 1, and of Li₄Ti₅O₁₂ (200) from Comparison Example Synthesis 3 with carbon black, and of Li₄₋ₓTi₅₋₂ₓCr₃ₓO_{12-δ} where x=0.4 (204′) from Synthesis 2 without carbon black. The measuring results are illustrated by the graph in FIG. 3, in which the capacity C in mAh/g is plotted against the number of cycles n.

FIG. 3 shows that Li₄₋ₓTi₅₋₂ₓCr₃ₓO₁₂ where x=0.1 (201), x=0.2 (202), x=0.4 (204), and Li₄₋ₓTi₅₋₂ₓCr₃ₓO_{12-δ} where x=0.4 (204′), for example where x≦0.4, have a good capacity reversibility and cycle stability, which in particular is higher than the capacity reversibility and cycle stability of Li₄₋ₓTi₅₋₂ₓCr₃ₓO₁₂ where x=0.7 (207), and x=0.9 (209).

Table 7—which shows the theoretical capacities of the lithium titanates Li₄₋ₓTi₅₋₂ₓCr₃ₓO₁₂ where x=0.1 (201), x=0.2 (202), x=0.4 (204), x=0.7 (207), and x=0.9 (209) from Synthesis 1 and Li₄Ti₅O₁₂ (200) from Comparison Example Synthesis 3—shows that Li₄₋ₓTi₅₋₂ₓCr₃ₓO₁₂ where x=0.1 (201), x=0.2 (202), x=0.4 (204), for example where x≦0.4 m additionally has a higher theoretical capacity than Li₄₋ₓTi₅₋₂ₓCr₃ₓO₁₂ where x=0.7 (207), and x=0.9 (209).

TABLE 7
Theoretical capacities of the chromium-doped lithium titanates
according to Synthesis 1 and of undoped lithium titanate

| Li₄₋ₓTi₅₋₂ₓCr₃ₓO₁₂ | Theoretical capacity [mAh/g] |
|---|---|
| x = 0 (Li₄Ti₅O₁₂) 200 | 175.16 |
| x = 0.1 (Li_{3.9}Ti_{4.8}Cr_{0.3}O₁₂) 201 | 173.19 |
| x = 0.2 (Li_{3.8}Ti_{4.6}Cr_{0.6}O₁₂) 202 | 171.15 |
| x = 0.4 (Li_{3.6}Ti_{4.2}Cr_{1.2}O₁₂) 204 | 167.36 |
| x = 0.7 (Li_{3.3}Ti_{3.6}Cr_{2.1}O₁₂) 207 | 162.03 |
| x = 0.9 (Li_{3.1}Ti_{3.2}Cr_{2.7}O₁₂) 209 | 158.62 |

What is claimed is:

1. A cathode material for a lithium cell, comprising:
a chromium-doped lithium titanate.

2. The cathode material of claim 1, wherein the chromium-doped lithium titanate has the general chemical formula:
Li₄₋ₓTi₅₋₂ₓCr₃ₓO_{12-δ},
where 0<x≦0.6, and
where δ denotes oxygen vacancies and 0≦δ applies.

3. The cathode material of claim 1, wherein the cathode material also includes sulfur.

4. The cathode material of claim 1, wherein the cathode material also includes carbon.

5. The cathode material of claim 2, wherein 0<δ applies.

6. The cathode material of claim 2, wherein 0<δ applies, and the cathode material is free of conductive carbon.

7. The cathode material of claim 2, wherein δ=0 applies, and the cathode material includes carbon.

8. The cathode material of claim 2, wherein 0.1≦x≦0.5 applies.

9. The cathode material of claim 1, wherein the chromium-doped lithium titanate includes a spinel structure.

10. The cathode material of claim 1, wherein the chromium-doped lithium titanate is made by synthesizing a chromium-doped lithium titanate, by making a chromium-doped lithium titanate with solid-state synthesis, and calcine forming the chromium-doped lithium titanate having a spinel structure, wherein chromium is used in the solid-state synthesis.

11. A chromium-doped lithium titanate, comprising:
a chromium-doped lithium titanate having the general chemical formula:
Li₄₋ₓTi₅₋₂ₓCr₃ₓO_{12-δ},
where 0<x≦0.5, and
where δ denotes oxygen vacancies and 0<δ applies.

12. The chromium-doped lithium titanate of claim 11, wherein 0.1≦x≦0.5 applies.

13. The chromium-doped lithium titanate of claim 11, wherein the chromium-doped lithium titanate is made by synthesizing a chromium-doped lithium titanate, by making a chromium-doped lithium titanate with solid-state synthesis, and calcine forming the chromium-doped lithium titanate having a spinel structure, wherein chromium is used in the solid-state synthesis.

14. A method for synthesizing a chromium-doped lithium titanate, the method comprising:
making a chromium-doped lithium titanate with solid-state synthesis; and
calcine forming the chromium-doped lithium titanate having a spinel structure;
wherein chromium is used in the solid-state synthesis.

15. A lithium cell and/or lithium battery, comprising:
at least one of:
a cathode material for the lithium cell, including a chromium-doped lithium titanate;
a chromium-doped lithium titanate having the general chemical formula:
Li₄₋ₓTi₅₋₂ₓCr₃ₓO_{12-δ},
where 0<x≦0.5, and
where δ denotes oxygen vacancies and 0<δ applies; and
a chromium-doped lithium titanate made by synthesizing a chromium-doped lithium titanate, by making a chromium-doped lithium titanate with solid-state synthesis, and calcine forming the chromium-doped lithium titanate having a spinel structure, wherein chromium is used in the solid-state synthesis.

16. The cathode material of claim 1, wherein the lithium cell includes a lithium-sulfur cell.

17. The cathode material of claim 2, wherein 0.1≦x≦0.4 applies.

18. The chromium-doped lithium titanate of claim 11, wherein 0.1≦x≦0.4 applies.

19. The method of claim 14, wherein chromium is used in the solid-state synthesis at a molar ratio to titanium which is in a range from 1:2 to 1:16.

20. The method of claim 14, wherein chromium is used in the solid-state synthesis at a molar ratio to titanium which is in a range from 1:2 to 1:16, in particular a chromium (III) salt being used in the solid-state synthesis and/or the calcining is performed under a reducing atmosphere.

21. The method of claim 14, wherein the chromium-doped lithium titanate has a spinel structure.

22. The lithium cell and/or lithium battery of claim 15, wherein the lithium cell and/or lithium battery includes a lithium-sulfur cell and/or battery.

23. The lithium cell and/or lithium battery of claim 15, wherein the lithium cell and/or lithium battery includes a lithium-sulfur solid-state cell and/or battery.
